(19) United States
(12) Patent Application Publication
(10) Pub. No.: US 2026/0029656 A1
(43) Pub. Date: Jan. 29, 2026

(54) PULSE COMPRESSION ELECTRUM GRATING AND ITS PREPARATION METHOD

(71) Applicant: Shanghai Institute of Optics and Fine Mechanics, Chinese Academy of Science, Shanghai (CN)

(72) Inventors: Yunxia JIN, Shanghai (CN); Yuxing HAN, Shanghai (CN); Fanyu KONG, Shanghai (CN); Hongchao CAO, Shanghai (CN); Yibin ZHANG, Shanghai (CN); Jianda SHAO, Shanghai (CN)

(21) Appl. No.: 19/086,114

(22) Filed: Mar. 20, 2025

Related U.S. Application Data
(63) Continuation of application No. PCT/CN2022/125609, filed on Oct. 17, 2022.

(30) Foreign Application Priority Data
Sep. 29, 2022 (CN) 202211198640.9

(51) Int. Cl. G02B 27/09; G02B 5/18; G02B 27/00

(52) U.S. Cl. CPC G02B 27/0944; G02B 5/1857; G02B 27/0012

(57) ABSTRACT

A pulse-compressed electrum grating comprises a metal layer that is composed of a binary or multi-element mixture of gold-based materials containing silver and platinum group elements in appropriate proportions, or a gold-on-silver thin film structure. A preparation process comprises optimization of the characteristic contour parameters of the electrum grating and the material ratio thereof. The electrum grating, without degrading traditional optical performance of gold gratings, broadens high-diffraction-efficiency wavelength range of the grating, addresses or improves the oxidation susceptibility of pure silver gratings, and further enhances the laser damage threshold of gold gratings. The process parameters support fabrication of gratings with an aperture size up to the meter level. The gratings and related process parameters support development of devices ranging from spectrometers and commercial ultrafast lasers to large-scale high-peak-power lasers, which have significant implications for the advancement of pulse compression gratings.

### CROSS-REFERENCE TO RELATED APPLICATIONS

The subject application is a continuation of PCT/CN2022/125609 filed on Oct. 17, 2022, which in turn claims priority on Chinese Patent Application No. CN202211198640.9 filed on Sep. 29, 2022 in China. The contents and subject matters of the PCT international stage application and the Chinese priority application are incorporated herein by reference in the entirety.

### TECHNICAL FIELD

The present invention relates to a reflective grating, and more particularly, to an electrum grating for pulse compression and its preparation method.

### BACKGROUND ART

The field of ultra-intense and ultra-short laser is currently at a critical stage of achieving significant breakthrough and expanding application. Internationally, there is a strong push for the development of ultra-intense and ultra-short laser sources as well as cutting-edge scientific and technological innovation platforms based thereon. Research institutes and scientific organizations worldwide are effectively utilizing Chirped Pulse Amplification (CPA) and Optical Parametric Chirped Pulse Amplification (OPCPA) to push the peak power of lasers to the tens of petawatt (PW) level. Within the next decade, 100 PW ultra-intense and ultra-short laser facilities are expected to be progressively commissioned globally. The race to achieve even higher peak power has become a competitive arena among major countries.

In the two laser amplification technologies, CPA and OPCPA, the grating compressor is the core module, and the key component of the grating compressor is the grating. Metal gratings, due to the advantages of wide bandwidth, high efficiency, excellent surface figure, and broad angular spectrum, are highly favored in both small-scale and large-scale laser systems.

Currently, to ensure the long-term service environment and stable performance of pulse compression gratings, the metal layer is almost exclusively made of pure gold. For high-energy laser systems, the purity of gold is required to reach 99.99% or even 99.999%. According to the current and future needs for high-peak-power laser construction, gold gratings are expected to achieve an average diffraction efficiency of 90-94% across different bandwidths in the 700-1200 nm range. The laser-induced damage threshold (LIDT) is already close to its limit. Therefore, there is an urgent need to develop pulse compression metal gratings with higher LIDT and superior optical and thermomechanical properties while retaining the advantages of traditional gold gratings.

No one at home and abroad has proposed the design, preparation, testing, and application of pulse-compressed electrum gratings. Pulse-compressed electrum gratings refer to binary mixtures containing silver in a gold base, or gratings with a gold top and a silver bottom. The metal film layer with high electrical conductivity helps to improve the diffraction efficiency of the metal grating, enhance the laser damage threshold, and expand the high-efficiency bandwidth. The multi-component hybrid structure helps to improve the oxidation resistance of silver and enhance the deformation resistance of pure gold or silver. The research on pulse-compressed electrum gratings is of great significance.

### SUMMARY OF THE INVENTION

The technical problem to be solved by the present invention is to provide a pulse compression electrum grating and its preparation method. The grating, while ensuring the optical performance of traditional pure gold gratings, broadens the high-diffraction-efficiency wavelength range of the grating; addresses or improves the oxidation susceptibility of pure silver gratings; and further enhances the laser damage threshold of gold gratings. It has significant scientific research, economics, and application value.

The technical solution of the present invention is as follows:

On one hand, the present invention provides a pulse compression electrum grating, characterized in that the metal layer of the grating is a gold-on-silver metal film, or a binary or multi-component mixture film containing other metals in addition to gold, or a gold top with a base of a monometallic or multi-metallic mixture film containing metals other than gold.

Further, the gold-on-silver metal film refers to the deposition of a pure silver film on the grating mask, followed by the deposition of a pure gold film on top of the silver film.

Further, the binary mixture film comprises gold-based binary alloy films containing silver, copper, or platinum group metals (such as platinum, palladium, iridium, ruthenium, rhodium, and osmium).

Further, the gold-based silver-containing binary alloy film refers to the direct deposition of an alloy film with different atomic percentages of gold and silver onto the grating mask.

Further, the multi-component mixture film comprises gold-based ternary mixture films containing iridium and platinum, or multi-component mixture films containing silver, iridium, and platinum.

On the other hand, the present invention also provides a method for preparing a pulse compression electrum grating, which comprises the following steps:
1) Design of the Electrum Grating:

The characteristic contour function of the grating is defined as

$$h ( x ) = max \{ 0 , {H [ 1 - \vert sin ( π \frac{x}{d \cdot f} ) \vert ]}^{σ} \} ,$$

The characteristic contour function of the grating is defined as

$$h ( x ) = max \{ 0 , {H [ 1 - \vert 2 \frac{x}{d \cdot f} \vert ]}^{σ} \} ,$$

Herein, h represents the depth of the grating contour in the vertical direction, x represents the length of the grating in the horizontal direction, H represents the maximum groove depth, d represents the grating period, f represents the duty cycle of the grating, and σ represents the shape factor of the grating contour;

The characteristic functions one and two are both suitable for simulating real grating profiles. In the design, when the same parameters mentioned above are selected, characteristic function one is suitable for simulating gratings with an S-shaped transition from the top to the bottom of the grating ridge or with a flat top. Characteristic function two is suitable for simulating gratings with a sudden truncation at the bottom of the grating ridge, outwardly convex sidewalls, or a sharp top.

The initial wavelength is selected based on the requirements. The characteristic contour function of the grating is chosen, and the optimal groove depth, period, duty cycle, and shape factor for achieving high diffraction efficiency within a specific spectral bandwidth are determined through global optimization or local optimization algorithms;
2) Preparation of the Electrum Grating Mask:

The grating designed in Step 1 is prepared, comprising substrate cleaning, coating, baking, exposure, and development;
3) Deposition of the Electrum Layer:

Using preparation techniques such as magnetron sputtering or electron-beam evaporation, an electrum film with a gold top and silver bottom is deposited, or binary or multi-component alloy films containing silver or other metals in a gold base are prepared using dual-source or multi-component co-deposition techniques.

By adjusting parameters such as the base vacuum pressure, power supply power, gas flow rate, working gas pressure, and deposition rate, electrum films with different compositions are prepared.

The thickness, roughness, and elemental content of the electrum film are tested;

Using magnetron sputtering technology, the deposition parameters for Au and Ag are controlled as follows: a base vacuum pressure of 1×10⁻³ to 8×10⁻⁴ Pa, argon gas flow rate of 40-50 sccm, power supply power of 100-600 W, and working gas pressure of 0.3-0.5 Pa. For Step 3, a gold-on-silver metal film and a gold-silver binary alloy film with a total thickness of 50-300 nm are deposited on the grating mask;
4) Optimization of Electrum Grating: The optical performance of the prepared electrum gratings with different top and bottom layer thicknesses (gold-on-silver) or different elemental compositions is characterized. The optimal electrum grating is selected based on the best overall performance in terms of reflectivity, spectral bandwidth, and angular bandwidth;
5) Damage Performance Testing of Electrum Grating: According to ISO 21254, single-pulse or multi-pulse damage testing is conducted on the electrum grating prepared in Step 4; The technical effects of the present invention are as follows:
1) The grating of the present invention can broaden the high-diffraction-efficiency wavelength range without degrading the optical performance of traditional gold gratings and further enhance the laser damage threshold of gold gratings.
2) The grating of the present invention has strong compatibility and can directly replace the gold gratings currently in service under existing application conditions. It improves the safety threshold of gold gratings used in high-power lasers and ensures higher power output from the lasers.
3) The process parameters of the grating of the present invention are stable and can support the fabrication of gratings with an aperture size up to the meter level.
4) The grating of the present invention can address or improve the oxidation susceptibility of pure silver gratings. It has strong environmental stability and a long service life.
5) The grating and related process parameters of the present invention can support the development of various devices, ranging from spectrometers and commercial ultrafast lasers to large-scale high-peak-power lasers. It has significant economic and practical value in fields such as spectrometers and high-power lasers.

### BRIEF DESCRIPTION OF THE DRAWINGS

FIG. 1 is a structural diagram of Example 1 of the pulse compression electrum grating of the present invention. The vertical axis represents longitudinal height.

FIG. 2 is a reflectivity chart of the grating metal layer for Comparative Example 1 and Example 1 of the pulse compression electrum grating of the present invention. The incident light is TM-polarized with an incident angle of 62°. The vertical axis represents reflectance (%).

FIG. 3 is a chart of the −1^{st} order diffraction efficiency for Comparative Example 1 and Example 1. The incident light is TM-polarized with an incident angle of 62°, a grating line density of 1400 g/mm, a duty cycle of 0.7, a groove depth of 220 nm, and a shape factor of 3. The vertical axis represents −1^{st} order diffraction efficiency (%).

FIG. 4 is a damage test probability chart for Comparative Example 1 and Example 1. The test laser has a central wavelength of 925 nm, a bandwidth of 825-1025 nm, and a pulse width of 3 ns. The vertical axis represents probability of injury (%).

FIG. 5 is a structural diagram of Examples 2, 3, and 4 of the pulse compression electrum grating of the present invention. The vertical axis represents longitudinal height.

FIG. 6 is a reflectivity chart of the grating metal layer for Comparative Example 2 and Example 2 of the pulse compression electrum grating of the present invention. The incident light is TM-polarized with an incident angle of 62°. The vertical axis represents reflectance (%).

FIG. 7 is a chart of the −1^{st} order diffraction efficiency for Comparative Example 2 and Example 2. The incident light is TM-polarized with an incident angle of 50°, a grating line density of 1443 g/mm, a duty cycle of 0.7, a groove depth of 200 nm, and a shape factor of 1.8. The vertical axis represents −1^{st} order diffraction efficiency (%).

FIG. 8 is a damage test probability chart for Comparative Example 2 and Example 2. The test laser has a central wavelength of 925 nm, a bandwidth of 825-1025 nm, and a pulse width of 15 fs. The vertical axis represents probability of injury (%).

FIG. 9 is a chart of the −1^{st} order diffraction efficiency for Comparative Example 2 and Example 3. The incident light is TM-polarized with an incident angle of 54°, a grating line density of 1480 g/mm, a duty cycle of 0.6, a groove depth of 200 nm, and a shape factor of 2.5. The vertical axis represents −1^{st} order diffraction efficiency (%).

FIG. 10 is a damage test probability chart for Comparative Example 2 and Example 4. The test laser has a central wavelength of 925 nm, a bandwidth of 825-1025 nm, and a pulse width of 15 fs. The vertical axis represents probability of injury (%).

FIG. 11 is a chart of the −1^{st} order diffraction efficiency for Comparative Example 1 and Example 5. The incident light is TM-polarized with a wavelength of 920 nm, a grating line density of 1400 g/mm, a duty cycle of 0.7, a groove depth of 220 nm, and a shape factor of 3. The vertical axis represents −1^{st} order diffraction efficiency (%).

In the figures, reference numbers are: 1—Gold-on-silver electrum grating; 2—Gold-based electrum grating containing silver, copper, or other metals in binary or multi-component mixtures; 3—Gold layer; 4—Silver or platinum group metal (binary or multi-component) mixture layer; 5—Mask layer; 6—Electrum layer.

### DETAILED DESCRIPTION OF THE INVENTION

Below, the present invention is further explained in conjunction with specific examples and the accompanying drawings. However, the specific examples and accompanying drawings should not be construed as limiting the scope of protection of the present invention.

### Example 1

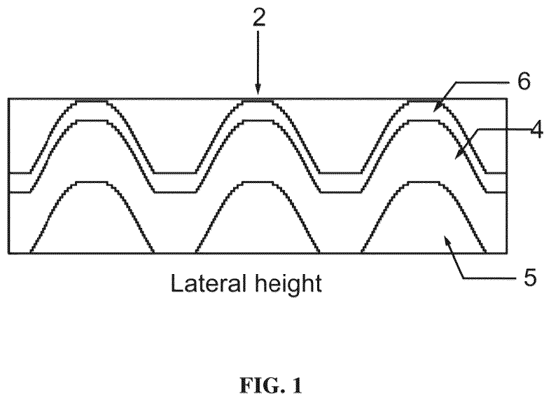

A gold-on-silver electrum grating was prepared as shown in FIG. 1. Using magnetron sputtering technology, five sets of gold-on-silver metal films with a total thickness of 200 nm were deposited, with the following material combinations: 6 nm Au+194 nm Ag, 8 nm Au+192 nm Ag, 10 nm Au+190 nm Ag, 12 nm Au+188 nm Ag, and 15 nm Au+185 nm Ag. The sputtering parameters for Au and Ag were as follows: a base vacuum pressure of 8×10⁻⁴ Pa, an argon gas flow rate of 40 sccm, a power supply power of 300 W, and a working gas pressure of 0.5 Pa. The sputtering rates for Au and Ag were 0.42 s/nm and 0.40 s/nm, respectively.

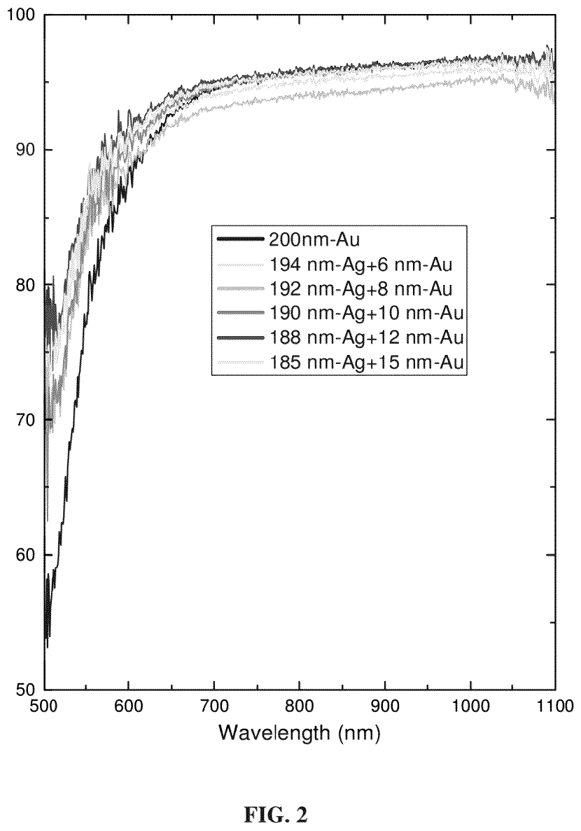

The diffraction efficiency measurement system was used to test the spectra of the five sets of samples with TM-polarized light. The reflectivity of the samples in the 500-1150 nm wavelength range was tested at a fixed angle of 62°. As shown in FIG. 2, all the gold-on-silver samples outperformed the pure gold samples in terms of bandwidth. The sample with 12 nm Au+188 nm Ag demonstrated superior performance in both spectral bandwidth and absolute efficiency compared to the pure gold sample.

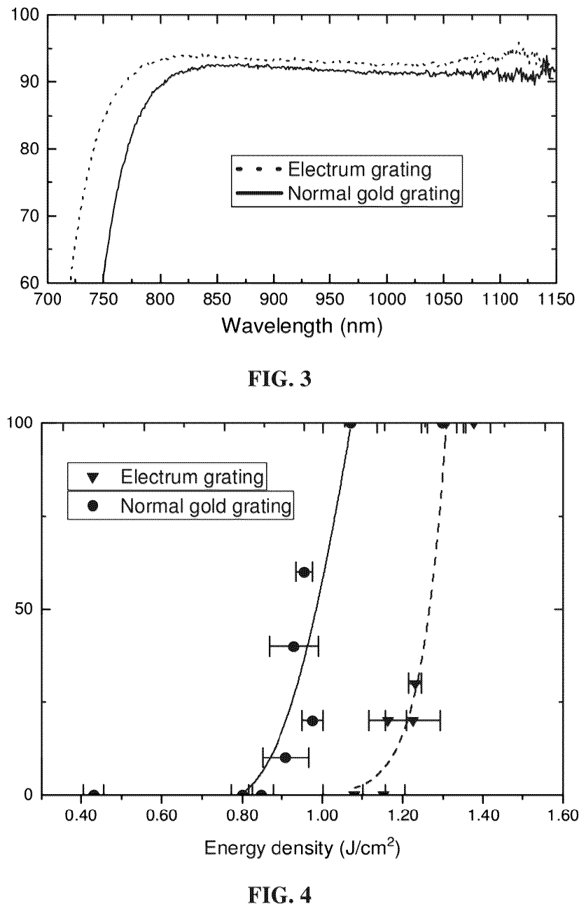

The grating parameters designed in the example were as follows: a line density of 1400 lines/mm, a duty cycle of 0.7, a groove depth of 220 nm, and a shape factor of 3. Gratings with the above specifications were fabricated. The substrate was cleaned with ethanol or acetone. A photoresist layer approximately 220 nm thick was spin-coated onto the substrate at a rate of 2800 r/min for 30 seconds using a spin coater, and then the substrate was baked at 100° C. for 2 minutes. Subsequently, the substrate coated with the photoresist layer was exposed to 325 nm light at an exposure power of 50 μW for 200 seconds using a two-beam interference exposure method. The exposed sample was then immersed in a sodium hydroxide solution with a mass fraction concentration of 4% % for 50 seconds. Finally, a gold-on-silver electrum grating with a thickness of 12 nm Au+188 nm Ag was deposited using magnetron sputtering technology. The diffraction efficiency of the sample in the 700-1150 nm wavelength range was tested at a fixed angle of 62°. As shown in FIG. 3, compared to traditional gold gratings, the measured −1^{st} order diffraction efficiency of the electrum grating is higher than 90% in the range of 770 nm to greater than 1150 nm. The overall diffraction efficiency has increased, and the bandwidth has been extended towards shorter wavelengths by nearly 40 nm.

According to the ISO 21254 Standard, a 1-on-1 laser damage threshold (LIDT) test was conducted on the samples. As shown in FIG. 4, under the test conditions of a central wavelength of 925 nm, a bandwidth of 825-1025 nm, and a pulse width of 3 ns, the laser-induced damage threshold of the electrum grating was increased by nearly 40% compared to that of the pure gold grating.

### Example 2

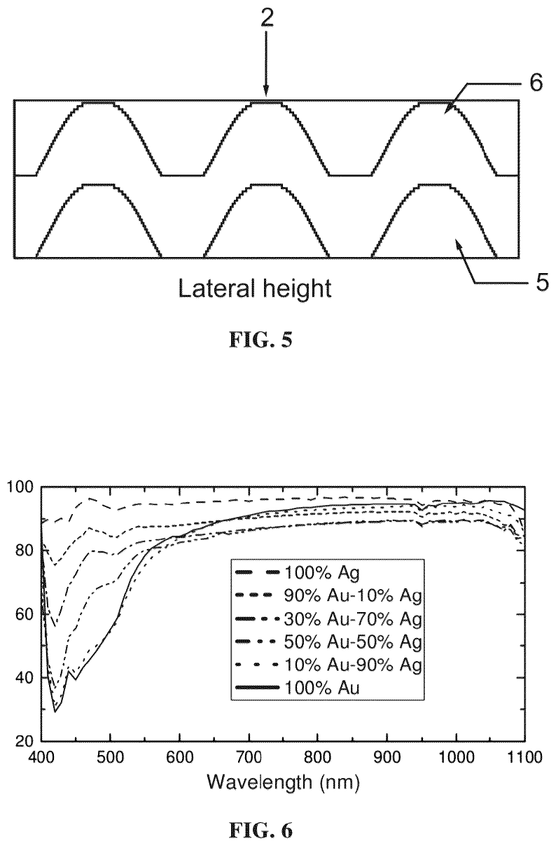

A gold-based palladium-containing binary mixed amber-gold grating was prepared with the structure as shown in FIG. 5. Using magnetron dual-source co-sputtering technology, four sets of gold-palladium binary alloy gratings with a total thickness of 200 nm were prepared. The composition ratios of gold (Au) and palladium (Pd) were 90%-Au+10%-Pd, 50%-Au+50%-Pd, 30%-Au+70%-Pd, and 10%-Au+90%-Pd, respectively. The sputtering parameters included a background vacuum pressure of 1×10⁻³ Pa, an argon gas flow rate of 50 sccm, a power supply power of 500 W, and a working gas pressure of 0.3 Pa. The sputtering rates for Au and Pd were 0.38 s/nm and 0.36 s/nm, respectively.

The diffraction efficiency measurement system was used to test the spectra of the four sets of samples with TM-polarized light. The reflectivity of the samples in the 400-1100 nm wavelength range was tested at a fixed angle of 62°. As shown in FIG. 6, all the gold-palladium samples outperformed the pure gold samples in terms of bandwidth. The sample with 10%-Au+90%-Pd demonstrated superior performance in both spectral bandwidth and absolute efficiency compared to the pure gold sample.

The grating parameters designed in this example were as follows: a line density of 1443 lines/mm, a duty cycle of 0.7, a groove depth of 200 nm, and a shape factor of 1.8. Gratings with the above specifications were fabricated. The substrate was cleaned with ethanol or acetone. A photoresist layer approximately 200 nm thick was spin-coated onto the substrate at a rate of 2500 r/min for 30 seconds using a spin coater, and then the substrate was baked at 100° C. for 2 minutes. Subsequently, the substrate coated with the photoresist layer was exposed to 325 nm light at an exposure power of 50 μW for 200 seconds using a two-beam interference exposure method. The exposed sample was then immersed in a sodium hydroxide solution with a mass fraction concentration of 4% % for 65 seconds. Finally, a 10%-Au+90%-Pd electrum grating with a thickness of 200 nm was deposited using magnetron dual-source co-sputtering technology.

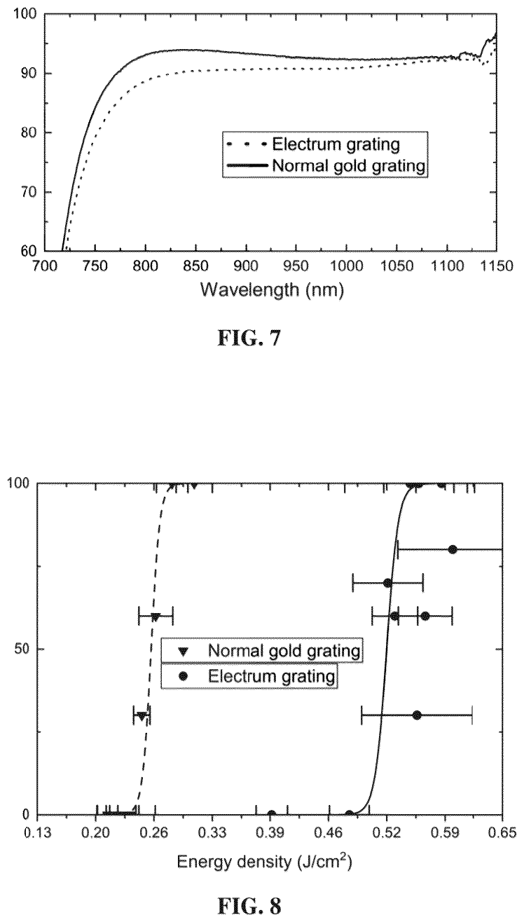

The −1^{st} order diffraction efficiency of the samples was tested at a fixed angle of 62° within the 700-1150 nm wavelength range. As shown in FIG. 7, the measured −1^{st} order diffraction efficiency of the electrum grating exceeded 90% in the range of 773-1150 nm. Compared to traditional gold gratings, the bandwidth was extended towards shorter wavelengths by approximately 65 nm.

As shown in FIG. 8, under the test conditions of a central wavelength of 925 nm, a bandwidth of 825-1025 nm, and a pulse width of 15 fs, the laser-induced damage threshold (LIDT) of the electrum grating was increased by nearly 113% compared to that of the pure gold grating.

### Example 3

A multi-component mixed electrum grating containing silver and platinum in a gold base was prepared with the structure as shown in FIG. 5. The grating parameters designed in this example were as follows: a line density of 1480 lines/mm, a duty cycle of 0.7, a groove depth of 200 nm, and a shape factor of 2.5. Gratings with the above specifications were fabricated. The substrate was cleaned with ethanol or acetone. A photoresist layer approximately 220 nm thick was spin-coated onto the substrate at a rate of 2800 r/min for 30 seconds using a spin coater, and then the substrate was baked at 100° C. for 2 minutes. Subsequently, the substrate coated with the photoresist layer was exposed to 325 nm light at an exposure power of 50 μW for 200 seconds using a two-beam interference exposure method. The exposed sample was then immersed in a sodium hydroxide solution with a mass fraction concentration of 4% % for 90 seconds. Finally, an electrum grating with a thickness of 200 nm and a composition of 80%-Au+10%-Ag+10%-Pt was deposited using magnetron dual-source co-sputtering technology.

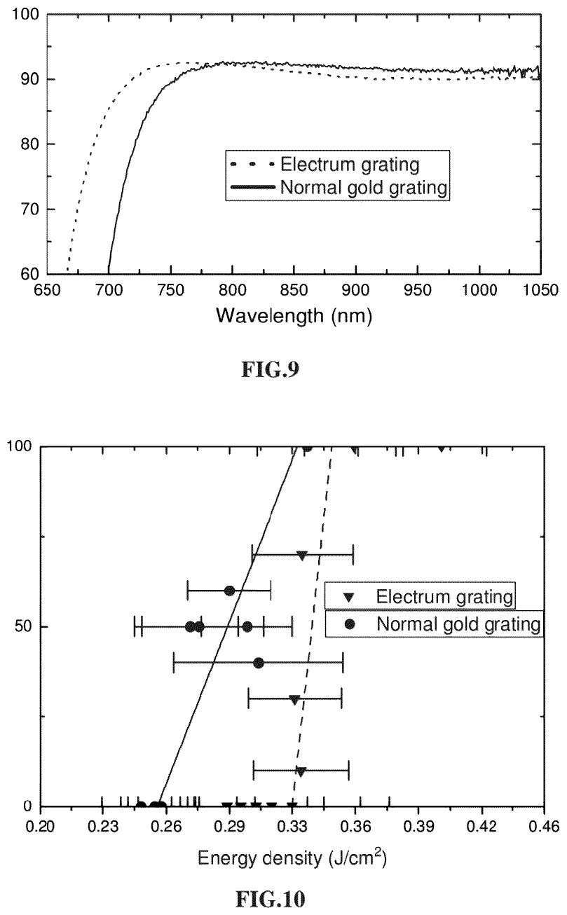

The −1^{st} order diffraction efficiency of the samples was tested at a fixed angle of 54° within the 650-1050 nm wavelength range. As shown in FIG. 9, the measured −1^{st} order diffraction efficiency of the electrum grating exceeded 90% in the range of 720-1050 nm. Compared to traditional gold gratings, the overall diffraction efficiency of the electrum grating decreased by no more than 1%, while the bandwidth was extended towards shorter wavelengths by nearly 40 nm.

### Example 4

A multi-component mixed electrum grating containing iridium and platinum in a gold base was prepared with the structure as shown in FIG. 5. The grating parameters designed in this example were as follows: a line density of 1480 lines/mm, a duty cycle of 0.7, a groove depth of 200 nm, and a shape factor of 2.5. Gratings with the above specifications were fabricated. The substrate was cleaned with ethanol or acetone. A photoresist layer approximately 220 nm thick was spin-coated onto the substrate at a rate of 2800 r/min for 30 seconds using a spin coater, and then the substrate was baked at 100° C. for 2 minutes. Subsequently, the substrate coated with the photoresist layer was exposed to 325 nm light at an exposure power of 50 μW for 200 seconds using a two-beam interference exposure method. The exposed sample was then immersed in a sodium hydroxide solution with a mass fraction concentration of 4% % for 90 seconds. Finally, an electrum grating with a thickness of 200 nm and a composition of 10%-Au+10%-Ir+80%-Pt was deposited using magnetron dual-source co-sputtering technology.

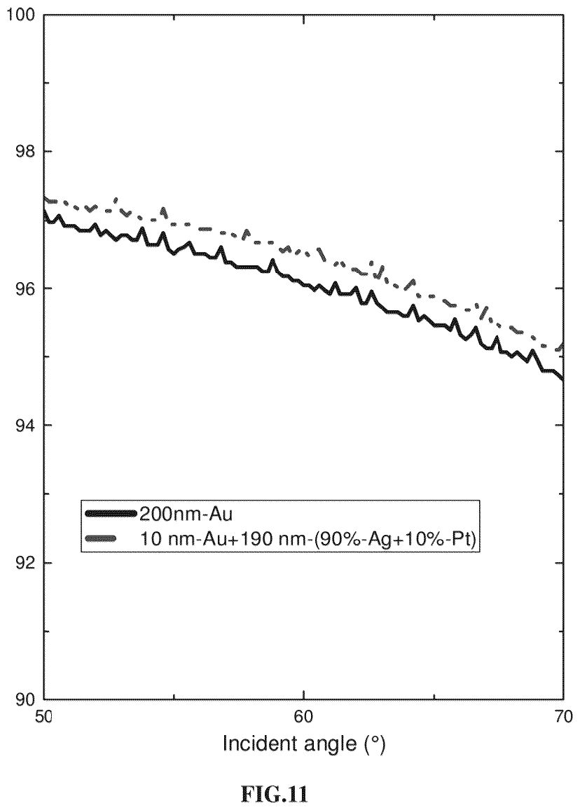

As shown in FIG. 10, under the test conditions of a central wavelength of 925 nm, a bandwidth of 825-1025 nm, and a pulse width of 15 fs, the laser-induced damage threshold (LIDT) of the electrum grating was increased by nearly 25% compared to that of the pure gold grating.

### Example 5

A gold-on-top, silver-platinum-on-bottom electrum grating was prepared with the structure as shown in FIG. 1. The grating parameters designed in the example were as follows: a line density of 1400 lines/mm. The fabrication process and parameters were consistent with those in Example 1. Finally, an electrum grating with a thickness of 10 nm Au+190 nm (90%-Ag+10%-Pt) was deposited using magnetron sputtering technology. The diffraction efficiency of the samples was tested at a fixed wavelength of 920 nm over an angular range of 50-70°. As shown in FIG. 11, the measured −1^{st} order diffraction efficiency of the electrum grating was higher than that of the traditional gold grating within the tested angular range.

### Comparative Example 1

A pure gold film with a total thickness of 200 nm was prepared using magnetron sputtering technology. The sputtering parameters for Au included a background vacuum pressure of 8×10⁻⁴ Pa, an argon gas flow rate of 40 sccm, a power supply power of 300 W, and a working gas pressure of 0.5 Pa. The sputtering rate was 0.42 s/nm.

The diffraction efficiency measurement system was used to test the reflectivity of the sample in the 500-1150 nm wavelength range at a fixed angle of 62° with TM-polarized light. The results are shown in FIG. 2.

The grating line density in the comparative example was 1400 lines/mm, and the fabrication process and parameters were consistent with those in Example 1. Finally, a pure gold grating with a thickness of 200 nm was deposited using magnetron sputtering technology. The diffraction efficiency of the sample was tested at a fixed angle of 62° within the 700-1150 nm wavelength range. As shown in FIG. 3, the −1^{st} order diffraction efficiency of the gold grating exceeded 90% in the wavelength range of 805-1150 nm.

According to the ISO 21254 standard, a 1-on-1 laser-induced damage threshold (LIDT) test was conducted on the sample. As shown in FIG. 4, under the test conditions of a central wavelength of 925 nm, a bandwidth of 825-1025 nm, and a pulse width of 3 ns, the laser-induced damage threshold of the gold grating was measured to be 0.8 J/cm².

### Comparative Example 2

A thin film with a total thickness of 200 nm and an elemental composition of 100%-Au was prepared using magnetron sputtering technology. The sputtering parameters for Au included a background vacuum pressure of 1×10⁻³ Pa, an argon gas flow rate of 50 sccm, a power supply power of 500 W, and a working gas pressure of 0.3 Pa. The sputtering rate was 0.38 s/nm.

The diffraction efficiency measurement system was used to test the spectral and angular characteristics of the sample with TM-polarized light. The reflectivity of the sample in the 400-1100 nm wavelength range was tested at a fixed angle of 62°. The results were shown in FIG. 6.

The grating line densities in the comparative example were 1480 lines/mm and 1443 lines/mm. The fabrication process and parameters were consistent with those in Examples 2 and 4. Finally, a pure gold grating with a thickness of 200 nm was deposited using magnetron sputtering technology.

The −1^{st} order diffraction efficiency of the 1443 lines/mm gold grating was shown in FIG. 7, with the −1^{st} order diffraction efficiency exceeding 90% in the wavelength range of 883-1150 nm. The −1^{st} order diffraction efficiency of the 1480 lines/mm gold grating was shown in FIG. 9, with the −1^{st} order diffraction efficiency exceeding 90% in the wavelength range of 760-1050 nm.

As shown in FIGS. 8 and 10, under the test conditions of a central wavelength of 925 nm, a bandwidth of 825-1025 nm, and a pulse width of 15 fs, the laser-induced damage threshold of the gold grating was measured to be 0.26 J/cm².

The above examples achieve an average diffraction efficiency of over 95% in the 700-1200 nm range by replacing the traditional pure gold (Au) grating layer with a gold-on-silver bilayer structure or a gold-based binary/multi-component alloy film containing silver/platinum group metals. The improvement leverages silver's high reflectivity across a broad spectrum, surpassing the 90-94% efficiency of pure gold gratings. The gold-based composite structure mitigates silver's oxidation through interfacial passivation, addressing the issues of pure silver's susceptibility to oxidation and pure gold's insufficient efficiency. Under 3 ns pulses, the laser-induced damage threshold increases from 0.8 J/cm² for pure gold to 1.12 J/cm². The gold top layer isolates the grating from environmental erosion, with no oxidation spots observed after humidity and heat testing. Additionally, two characteristic functions are employed to modulate the grating sidewall profiles, reducing localized electric field effects, minimizing damage, and expanding the Bragg condition applicability range, thereby enhancing the bandwidth.

The above examples are intended to further illustrate the invention to those skilled in the art but are not intended to limit the invention in any form. Ordinary technical personnel in this field may modify or replace the technical solutions of the invention without departing from the concept of the invention, and all such modifications and replacements are within the scope of protection of the invention.

We claim:

1. A pulse-compression electrum grating, comprising,
a substrate,
a grating mask layer provided on a surface of the substrate, and
a grating metal layer covering the grating mask layer,
wherein the grating metal layer is a gold-capped monometallic or multimetallic composite metal film, or is a gold-based binary composite film or multi-component composite film comprising other metals except gold; and
the grating mask layer comprises a periodic groove-like structure, and a depth h of a longitudinal grating profile thereof satisfies one of following formulae:
$${h}_{1} ( x ) = max \{ 0 , {H [ 1 - \vert sin ( π \frac{X}{d \cdot f} ) \vert ]}^{σ} \} or$$
$${h}_{2} ( x ) = max \{ 0 , {H [ 1 - \vert 2 \frac{x}{d \cdot f} \vert ]}^{σ} \}$$
wherein x is a length of a transverse grating profile, H is a maximum groove depth, dis a grating period, f is a grating aspect ratio, and σ is a shape factor of the grating profile.

2. The pulse-compression electrum grating according to claim 1, wherein the gold-capped monometallic or multimetallic composite metal film substrate comprises a gold-capped silver metal film substrate, and a gold-capped plus monometallic or multimetallic composite metal film substrate of other metals except gold.

3. The pulse-compression electrum grating according to claim 2, wherein the gold-capped silver metal film substrate is formed by plating a pure silver film on the grating mask and plating a pure gold film on the pure silver film.

4. The pulse-compression electrum grating according to claim 2, wherein the gold-capped plus monometallic or multimetallic composite metal film substrate of other metals except gold is formed by plating a monometallic or multimetallic composite film of silver and platinum group metals on the grating mask and plating the pure gold film on the monometallic or multimetallic composite film of the silver and platinum group metals.

5. The pulse-compression electrum grating according to claim 1, wherein the binary composite film is a gold-based silver-containing binary alloy film, a gold-based aluminum-containing binary alloy film, a gold-based copper-containing binary alloy film, or a gold-based platinum group metal-containing (platinum, palladium, iridium, ruthenium, rhodium, osmium) binary alloy film.

6. The pulse-compression electrum grating according to claim 5, wherein the gold-based silver-containing binary alloy film is formed by directly plating alloy films with different atomic percentages of gold and silver on the grating mask.

7. The pulse-compression electrum grating according to claim 1, wherein the multi-component composite film is a gold-based iridium-platinum-containing ternary composite film or a gold-based silver-iridium-platinum containing multi-component composite film.

8. A method for preparing the pulse-compression electrum grating according to claim 1, wherein the method comprises the steps of:
1) designing an electrum grating, wherein a first longitudinal grating profile depth function h₁(x) is used for simulating an S-shaped transition from a top to a bottom of a grating ridge, or a flat top, and a formula is as follows:
$${h}_{1} ( x ) = max \{ 0 , {H [ 1 - \vert sin ( π \frac{X}{d \cdot f} ) \vert ]}^{σ} \} ,$$
a second longitudinal grating profile depth function h₂(x) is used for simulating a sudden cut-off bottom of the grating ridge, a convex side wall, or a sharp top end, and a formula is as follows:
$${h}_{2} ( x ) = max \{ 0 , {H [ 1 - \vert 2 \frac{x}{d \cdot f} \vert ]}^{σ} \}$$
wherein in the formula, x is a length of a transverse grating profile, His a maximum groove depth, d is a grating period, f is a grating aspect ratio, and σ is a shape factor of the grating profile; and
selecting the longitudinal grating profile depth function and initial wavelength, and determining an optimal groove depth, a period, an aspect ratio, and a shape factor for high diffraction efficiency within a specific spectral bandwidth by global optimization or local optimization algorithm;
2) preparing an electrum grating mask layer by forming the grating mask layer having the periodic groove-like structure by cleaning, gluing, baking, exposing and developing the substrate;
3) plating the electrum grating metal layer by successively plating a bottom metal film and a top gold film on the surface of the grating mask layer using magnetron sputtering or electron beam evaporation process, wherein a plating background vacuum degree of Au and Ag is from 1×10⁻³ to 8×10⁻⁴ Pa, a flow rate of argon gas is from 40 to 50 sccm, a power supply power is from 100 to 600 W, and a working pressure is from 0.3 to 0.5 Pa, so as to prepare electrum films with different ratios, and testing thickness.

9. The method for preparing the pulse-compression electrum grating according to claim 8, further comprising the steps of:
4) performing electrum grating performance test and screening: performing tests on reflection rate, diffraction efficiency, and laser-induced damage threshold of the electrum grating completed in step 3) and screening out a sample with an optimal comprehensive performance.

10. The method for preparing the pulse-compression electrum grating according to claim 8, wherein the bottom metal film is pure silver, a silver-platinum alloy, or a platinum-series metal composite, and a thickness of the bottom metal film is from 180 to 195 nm; a thickness of the top gold film is from 5 to 20 nm.
